(19) United States
(12) Patent Application Publication
(10) Pub. No.: US 2007/0293951 A1
(43) Pub. Date: Dec. 20, 2007

(54) MONITORING APPARATUS

(76) Inventors: Ichiro Takahashi, Inzai (JP); Seigo Kurokawa, Narashino (JP); Takeaki Mishima, Narashino (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/621,635

(22) Filed: Jan. 10, 2007

(30) Foreign Application Priority Data
May 30, 2006 (JP) 2006-149901

(51) Int. Cl. G05B 15/00

(52) U.S. Cl. 700/1

(57) ABSTRACT

A monitoring apparatus that captures data in a router into a monitoring apparatus to cope with a communication abnormality in a monitoring system that uses the router, a modem, and a network. The monitoring apparatus comprises input modules 343, 345 for being input with a signal from a monitored object 303; a CPU module 341 for processing the signal from the input modules 343, 345; a communication module 342; a data bus 352; and a power module 340. The communication module has two connectors 204, 206 or more each connected to the network; a connection terminal connected to a power supply buss 351; a connection terminal connected to the data bus 352; a memory; and a CPU.

### INCORPORATION BY REFERENCE

The present application claims priority from Japanese application JP 2006-149901 filed on May 30, 2006, the content of which is hereby incorporated by reference into this application.

### BACKGROUND OF THE INVENTION

The present invention relates to a monitoring apparatus, and more particularly, to a technology for monitoring water supply/distribution facilities of water supply and sewage systems, industrial production facilities, a sales data collection system or the like.

A conventional monitoring system has comprised a monitoring apparatus that is installed in a central monitoring room, and another monitoring apparatus that is installed at a work site where facilities to be monitored are set up and transmits data about the work site to the central monitoring room. Those monitoring apparatuses have been connected through dedicated digital lines or cable television lines. In the monitoring system, communications are performed between the monitoring apparatuses located at both ends of communication lines through routers or modems equipped in the monitoring apparatuses. (refer to for example a Japanese Laid-open Patent Application JP-A-10-327259).

### SUMMARY OF THE INVENTION

In the conventional monitoring system, data on whether the communication is in a normal state or in an abnormal state exists in the router. However, since the router is disposed outside the monitoring apparatus, it is difficult for the monitoring apparatus to obtain the data in the router. When a communication abnormality occurs in this monitoring system, it has been difficult to automatically determine in which of the router and a modem the problem exists. Therefore, it has been difficult to perform operations to recover automatically from the communication abnormality that took place.

Furthermore, in the conventional monitoring system, it is required that the work site and the central monitor side are always in communication with each other to monitor the work site state, therefore the communication abnormality can adversely affect the operation of the monitoring system. The communication abnormality frequently occurs in the network type monitoring system that uses the router and modem. Therefore, there is a requirement to automatically recover from the communication abnormality to shorten the time period during which the monitoring system suspends its operation due to the communication abnormality.

The present invention has been made in view of the above problems, and it is an object of the present invention to provide a monitoring apparatus in which a communication module for communicating with the network has a function equivalent to a router, and which is capable of obtaining communication state data to determine whether the communication abnormality is caused by the communication module or caused by the modem. In the event of the communication abnormality, the monitoring apparatus according to the present invention is capable of recovering the communication abnormality by performing a reset operation.

More specifically, the monitoring apparatus according to the present invention comprises: an input module for being input with a signal from a monitor object; a CPU module for processing the signal from the input module; the communication module for transmitting and receiving information to and from the network; a data bus for connecting the input module, CPU module, and communication module; and a power module for supplying the input module, CPU module, and communication module with power, wherein the communication module comprises: two or more connectors which are each connected to the network; a connection terminal connected to the power supply bus; a connection terminal connected to the data; a memory; and a CPU.

Furthermore, during the occurrence of an abnormality in the communication via the modem connected to any one of the two or more connectors of the communication module, the CPU module of the monitoring apparatus according to the present invention obtains communication module state information from the communication module via the data bus, and resets the modem when it determines that the communication module is normal.

The CPU module resets the modem by restoring the power supply to the modem after the suspension of power supply thereto.

Moreover, during the occurrence of an abnormality in the communication via the modem connected to any one of the two or more connectors of the communication module, the CPU module of the monitoring apparatus according to the present invention obtains communication module state information from the communication module via the data bus, and resets the communication module when it determines that the communication module is abnormal.

The CPU module resets the communication module by transmitting a restart signal to the communication module.

In addition, during the occurrence of an abnormality in the communication via the modem connected to any one of the two or more connectors of the communication module, the communication module refers to its own communication module state information, and resets itself when it determines that the communication module is abnormal.

The communication module state information is the information for enabling the determination of whether a control program for controlling the communication module is normally operating.

The communication module state information is also the information for enabling the determination of whether the data in the communication module is normally updated.

In addition, the input module of the monitoring apparatus according to the present invention is both a digital input module for being input with a digital signal and an analog module for being input with an analog signal.

Moreover, the monitoring apparatus of the present invention is provided with a digital output module for outputting the digital signal.

The digital output module is connected to the mode.

The above communication module is connected to an input/output device connected to the above monitor object.

With the present invention, it is possible to maintain a constant connection, to ensure efficient communication between the monitoring apparatus of the master station and the monitoring apparatus of a slave station through the use of the network that enables multiplex communications, to automatically recover from the communication abnormality that occurs due to problems in software of the modem or router, and thereby to reduce the downtime.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram showing an entire system structure including a monitoring apparatus of an embodiment;

FIG. 2 is an explanatory diagram of a structure in which a communication module having two Ethernets is disposed in the monitoring apparatus of the embodiment;

FIG. 3 is an explanatory diagram of an example in which a router is disposed outside the monitoring apparatus according to a conventional method; and

FIG. 4 is an explanatory diagram of a flow of recovery process performed by a CPU module of the monitoring apparatus in the event of detection of a communication abnormality in the embodiment.

### DESCRIPTION OF THE EMBODIMENTS

The best mode for carrying out the present invention will be described.

An embodiment of the monitoring apparatus of the present invention will be described below with reference to drawings.

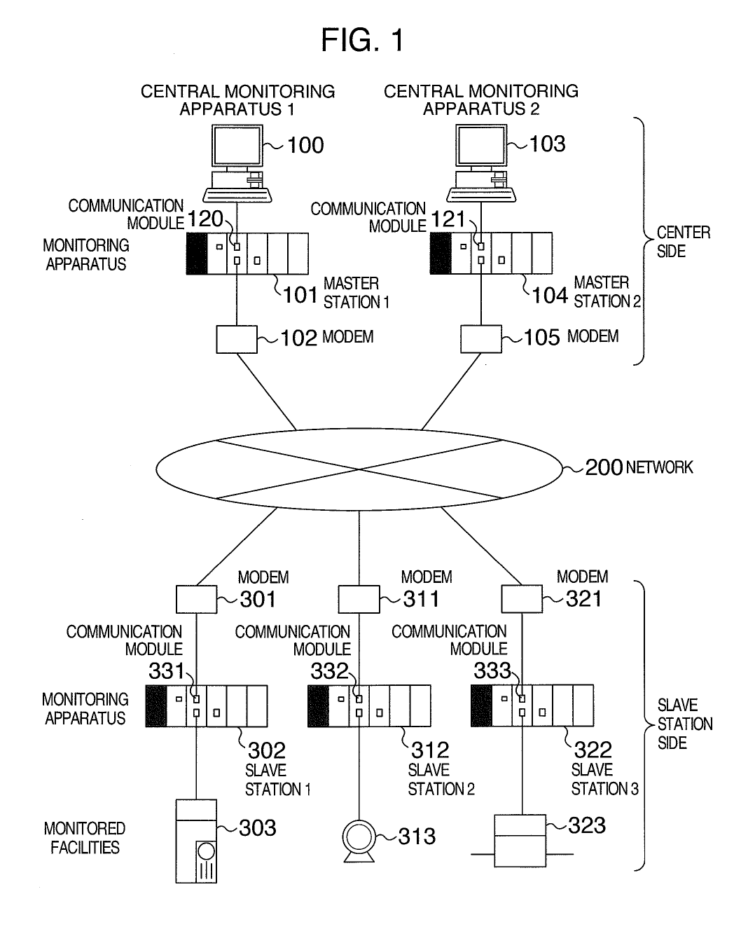

The embodiment will be described. FIG. 1 shows an entire structure of the monitoring apparatus of the present embodiment. In the center side, central monitoring apparatuses 100, 103, master station side monitoring apparatuses 101, 104, and modems 102, 105 are disposed. In the slave station side, modems 301, 311, 321, slave station side monitoring apparatuses 302, 312, 322 are disposed to monitor and control facilities to be monitored 303, 313, 323.

Since multiplex communications that use TCP/IP or the like are employed in the network 200, a plurality of center side monitoring apparatuses can be disposed and connected. The present embodiment shows an example in which two monitoring apparatuses, i.e., a central monitoring apparatus 1 (100) and a central monitoring apparatus 2 (103), are installed.

The central monitoring apparatus 1 (100) is connected to the network 200 via a master station side monitoring apparatus 1 (101) and the center side modem 102. In the monitoring apparatus 101, a communication module 120 is installed that has two connectors, i.e., one for communicating with the center side modem 102, and the other for communicating with the central monitoring apparatus 100. The master station side monitoring apparatus 101 communicates with the network 200 and the central monitoring apparatus 100 via the communication module 120.

The slave station side comprises modems 301, 311, 321; slave side monitoring apparatuses 302, 312, 322; and communication modules 331, 332, 333 which are disposed in the monitoring apparatuses. The monitored facilities side modems and slave station side monitoring apparatuses comprise the same hardware as that of the center side modems and monitoring apparatuses. The slave side monitoring apparatuses 302, 312, 322 capture the operation state and warning signals of monitored facilities 303, 313, 323 for transmitting to the center side monitoring apparatuses 101, 104. They also capture remote control signals transmitted from the center for outputting to the monitored facilities 303, 313, 323.

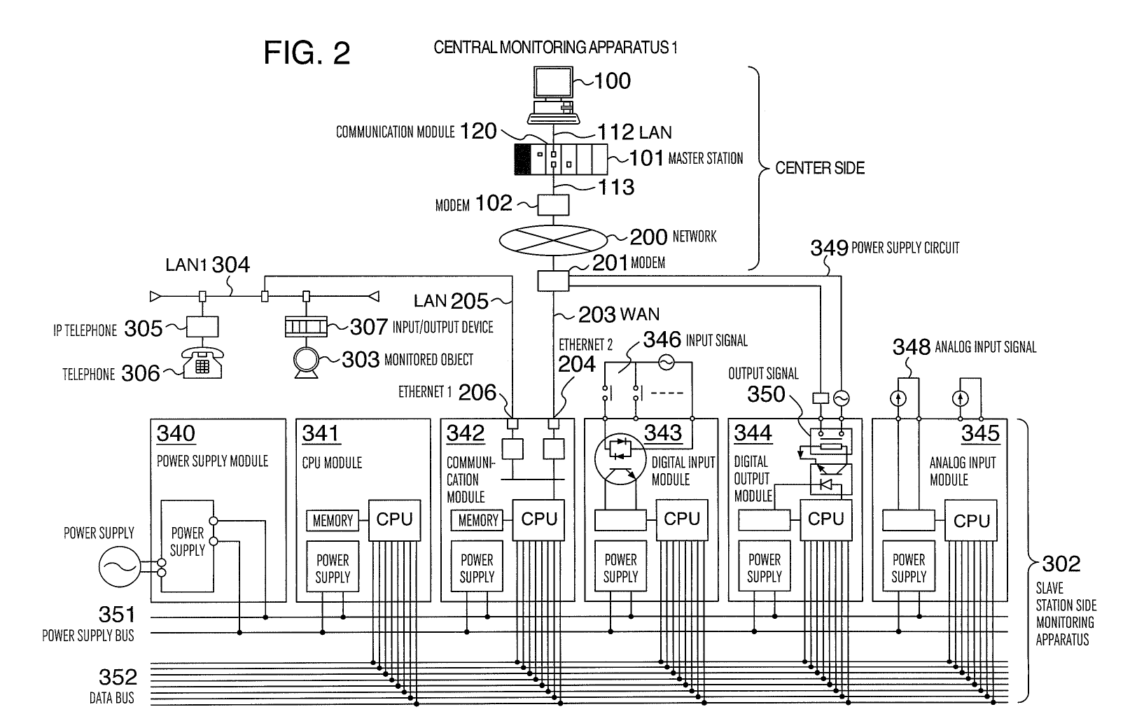

FIG. 2 shows a circuitry in the monitoring apparatus. Detail of the circuitry of the slave monitoring apparatus 302, 312 and 322 is shown in FIG. 2. It should be noted that the circuitry of the master station side monitoring apparatuses 101, 104, which is not shown in FIG. 2, is the same as that of the slave station side monitoring apparatuses.

The monitoring apparatus 302 comprises: a power supply module 340; a CPU module 341; a communication module 342; a digital input module 340; a digital output module 344; an analog input module 345; a power supply bus 351; and a data bus 352. The power supply module 340 supplies power for allowing each module in the monitoring apparatus to operate via the power supply bus 351. The CPU module 341 performs arithmetic computations based on the signals obtained from the communication module 342, input modules 343, 345 or the like via the data bus 352 and outputs signals to the output module 344 via the data bus 352, and creates data for the communication module 342 to communicate with the center side monitoring apparatus 101, and transmits and receives the data to and from the communication module 342 via the data bus 352.

The input modules (digital input module 343, and analogue input module 345) are input with signals 346, 348 and be monitored and transmit the signals to the CPU module 341 via the data bus 352.

The output module 344 receives the output signals created by the CPU module 341 via the data bus 352 to output a signal 350 to the outside of the monitoring apparatus.

A module in the CPU module 341 performs the entire process of the slave side monitoring apparatus 302 to transmit and receive data via the data bus 352. In contrast, each CPU in the communication module 342, input modules 343, 345, and output module 344 performs process in each module, and transmits and receives data to and from the CPU module 341 via the data bus 352.

The communication module 342 has two Ethernets™ and thereby has a function as a router. More specifically, the communication module 342 transmits and receives the data created by the CPU module of the slave station side monitoring apparatus 302 to and from the center side monitoring apparatus 101, and transmits and receives the data of an IP telephone 305 and an input/output device 307 connected to a LAN 1 (304) to and from the center side monitoring apparatus 101 of the WAN 203 side using the function of the router. The communication module 342 comprises: two connectors each connected to the network; a connection terminal connected to the power supply bus; a connection terminal connected to the data bus; a memory; and a CPU. It should be noted that the number of the connectors can be two or more.

The monitoring apparatus 302 is connected to the network 200 via a modem 201 to communicate with the center side monitoring apparatus 101.

A power supply circuit 349 from the modem 201 is a circuit that is powered on when the output signal 350 of the output module 344 is turned on. Therefore, when a communication abnormality occurs during the continuous operation of the modem 201, it is possible to automatically restart the modem and thereby to recover from the communication abnormality by once powering off the modem 201 and then restoring the power to it through the control of the output signal of the monitoring apparatus 301.

When a communication abnormality occurs in the monitoring apparatus that uses the network, the malfunction of the software of the modem or router often causes the communication abnormality. In such a communication abnormality, the communication is restored by restarting the software from the outset. The restart is performed by powering on the modem or router again after it is once powered off.

In the present embodiment, it is continuously determined whether the communication between the center side monitoring apparatus and the slave side monitoring apparatus is normal, and if it is determined that the communication is abnormal, then automatic recovery from the abnormality is performed.

The method of determining the communication abnormality includes the following process executed by the CPU module. The center side monitoring apparatus transmits data which constantly changes at a given time interval to the slave station side. The data is counted up like 1, 2, 3, 4 . . . The slave side monitoring apparatus also transmits data which changes at a given time interval to the center side monitoring apparatus in a similar manner. When it is detected that the data remains unchanged even if time passes, then the communication is determined to be abnormal. In the present embodiment, the communication module receives the data that is counted up from the other side for transmitting to the CPU module via the data bus, and the CPU module determines whether the communication is normal or abnormal. When the communication is determined to be abnormal, the CPU module performs the process to automatically recover from the community abnormality.

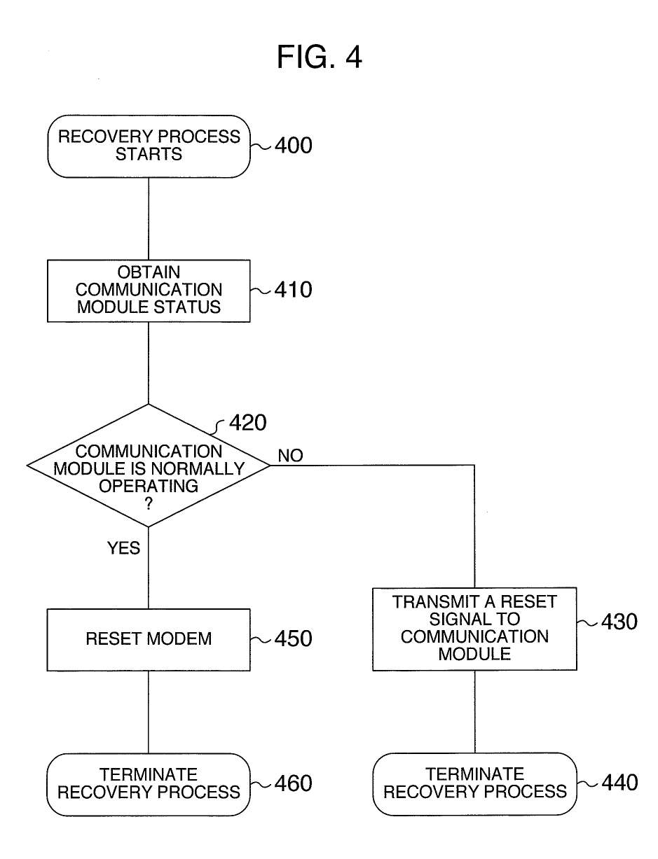

FIG. 4 shows a flowchart of a process for recovering from a communication abnormality which is detected by the CPU module of the monitoring apparatus. When the CPU module detects the communication abnormality, the recovery process starts (400). The CPU module obtains the status of the communication module (410). The CPU module determines the status of operation state in the communication module (420). If the CPU module determines that the status is normal, the communication module is not responsible for the communication abnormality, and the modem is reset (450). This enables the recovery from the communication abnormality which is caused by the malfunction of the modem, and then the recovery process is terminated (460). If the recovery from the communication abnormality is not achieved even with the process of step 450, the process returns to the first step of the recovery process (400), and, in this case, since the abnormality is often caused by a hardware failure, the hardware waits for being manually repaired while indicating the communication abnormality.

If it is determined that there is an abnormality in the communication module as a result of the determination of the operation state of the communication module at step 420, the communication module is restarted by transmitting a restart signal to the communication module via the data bus (430). This causes the software of the communication module to restart from the outset thereby to enable the recovery from the communication abnormality due to the software. Then, the recovery process terminates (440). If the recovery from the communication abnormality is not achieved, the process returns to the first step of the recovery process (400), and, in this case, since the abnormality is often caused by a hardware failure, the hardware waits for being manually repaired while indicating the communication abnormality.

A program for determining whether the operational state of the communication module is normal or abnormal operates in the communication module 342 to create the status of the communication module 342. This status is transmitted to the CPU module via the data bus 352. There are two statuses for indicating whether the communication module 342 is operating in a normal manner as follows:

(1) A status that indicates whether each of a plurality of programs in the communication module 342 is operating in a normal manner; and

(2) A status that indicates whether a management program (single program) for managing the operation of the plurality of programs in the communication module 342 is operating in a normal manner.

Here, the management program determines whether each program in the communication module is operating in a normal manner and creates the above status (1). The management program monitors whether the program operating in the communication module is counting up the data (1, 2, 3, . . . ) in the memory. When any of the program stops its operation, the count up of the data in the memory is suspended for a given time. In this event, the status (1) is abnormal.

When the management program itself stops its operation, the status (2) is abnormal. This status is created based on whether the management program itself can change a signal to a watchdog timer in the communication module at regular intervals (1, 0, 1, 0, . . . ). If the signal to the watchdog timer remains unchanged for a given period of time or longer, the status is abnormal. If the signal keeps changing, the status is normal.

Here, when the status of the communication module 342 is abnormal, a configuration may be made such that the communication module in the communication module is reset (430) by the communication module 342 itself instead of by the CPU module 341, and thereby the automatic recovery from the communication abnormality is achieved.

While the foregoing description has explained about the slave station side monitoring apparatus 302, the center side monitoring apparatus 101 is also recovered from the communication abnormality using the similar hardware and software. This also enables the center side monitoring apparatus 101 to automatically recover from the communication abnormality.

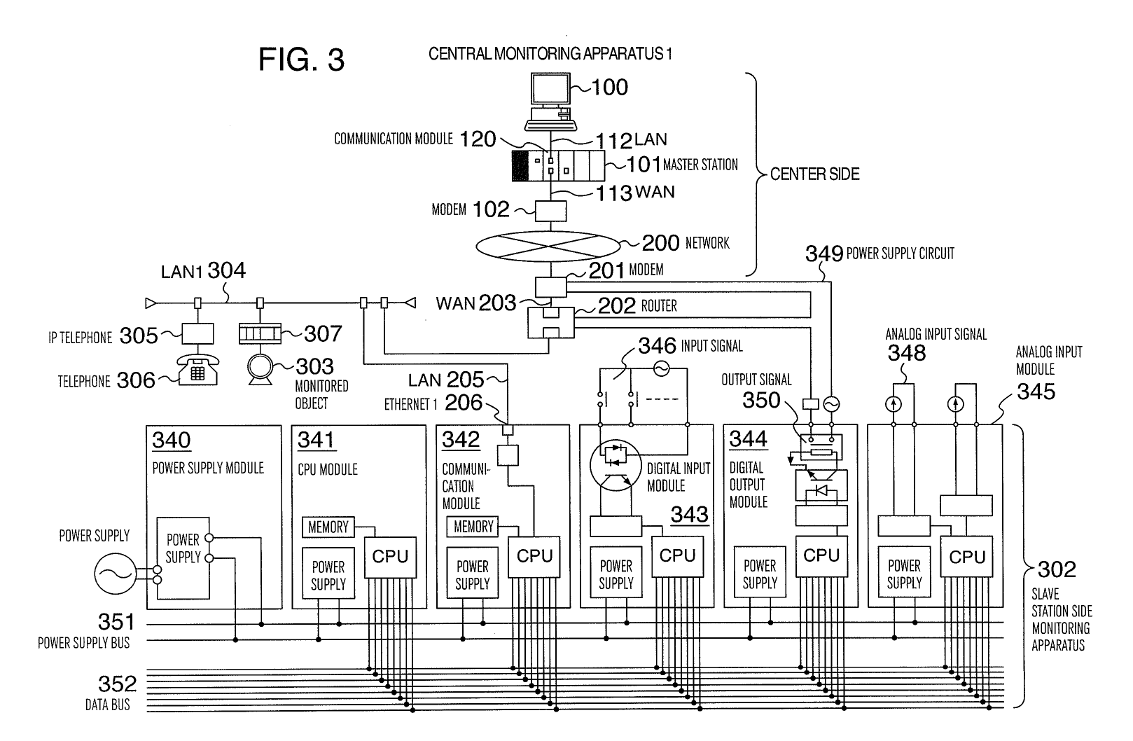

FIG. 3 shows a process of recovering from the communication abnormality in the conventional monitoring apparatus. In this case, a router 202 is externally disposed rather than internally to the monitoring apparatus 302. Moreover, the router 202 is not connected to the data bus 352 of the monitoring apparatus 302, and connected to the Ethernet 206. Therefore, in the event of detection of a communication abnormality by the monitoring apparatus 302, it is impossible to determine in which of the router 202 and the modem 201 the abnormality exists.

Therefore, the circuit 349 for supplying power to both the router 202 and modem 201 is configured to be turned on and off by an output signal 350 of the output module 344.

Accordingly, in the event of the communication abnormality, the reset process is executed by powering on and off both the modem 201 and router 202. In this case, when the communication abnormality occurs, the router 202 is powered on and off.

When the router 202 is powered on and off, there are following problems:

(1) When the router 202 is restarted after once being powered off, an IP address is sometimes assigned again to the router 202 from a DHCO server on the network during the start-up in addition to an address that is previously assigned. This is because the router 201 requests the DHCP server to reassign an IP address during power on or off. When the IP address is reassigned, the slave station side monitoring apparatus 302 communicates with the center side monitoring apparatus 101 again. Therefore, the IP address assignment operation occurs again, and a long time is required before the communication between the monitoring apparatuses is restored.

(2) If only the modem has to be powered on and off, a short time is required for the restoration of the communication. However, in order to restart the router, many pieces of software are activated in the router, requiring time. Thus, a long time is required for the recovery from the communication abnormality.

In contrast, in the present embodiment, as FIG. 4 shows, only any one of the modem and router, that is required to be restarted, is restarted. This shortens the time required before the communication is recovered. Generally, the modem experiences the communication abnormality more frequently than the router. Therefore, when communication abnormality occurs in the modem, the router does not have to be restarted.

Furthermore, in the present embodiment, when the router is restarted, power does not have to be turned off. Accordingly, the router can continuously use the IP address which was assigned before the communication abnormality occurs without requesting the DHCP server of the network to reassign an IP address during the start up of the router. Therefore, the time for reassigning the IP address is not needed, thus making it possible to reduce the time period in which there is an abnormality in the communication between the center side and the slave station side.

In the present embodiment, as shown in FIG. 2, the Ethernet 1 (206) is connected to a LAN, while the Ethernet 2 (204) is connected to a WAN. However, both may be connected to different LANs, with the center side monitoring apparatus and the slave station side monitoring apparatus being disposed between the LANs. Furthermore, while an example is shown in which the Ethernet 1 (206) and Ethernet 2 (204) are connected via Ethernet cables, one or both of them may be connected to a wireless LAN.

The devices described as modems (201, 102) in FIG. 2 of the present embodiment refer to signal converters for connecting the network and Ethernet including an ADSL modem for connecting to an ADSL line, a cable modem for connecting to a cable television, and a media converter for connecting to an optical line.

While the center side monitoring apparatus 101 is shown that has the same structure as that of the slave station side monitoring apparatus 302, the center side monitoring apparatus 101 may be a personal computer that performs communication in the same manner as the center side monitoring apparatus. In this event, only the slave side monitoring apparatus 302 detects the communication abnormality to automatically perform the recovery process, while the center side personal computer is recovered from the communication abnormality by manual operation.

In the network configured such that complex communication is performed via the TCP/IP, many of the communication abnormalities are caused by failures in the software of the modem or router. The present invention is capable of reducing the downtime which is caused by the communication abnormality.

It should be further understood by those skilled in the art that although the foregoing description has been made on embodiments of the invention, the invention is not limited thereto and various changes and modifications may be made without departing from the spirit of the invention and the scope of the appended claims.

1. A monitoring apparatus, comprising:
an input module (343) for being input with a signal from a monitored object;
a CPU module (341) for processing the signal from said input module;
a communication module (342) for transmitting and receiving information to and from the network;
a data bus (352) for connecting said input module, CPU module, and communication module; and
a power module (340) for supplying said input module, CPU module, and communication module with power,
wherein said communication module has: two or more connectors each connected to the network; a connection terminal for connecting to said power supply bus; a connection terminal for connecting to said data bus; a memory; and a CPU.

2. The monitoring apparatus according to claim 1, wherein said CPU module obtains communication module state information from said communication module via said data bus when there is a communication abnormality in the communication via a modem connected to any one of the two or more connectors of said communication module, and upon determination that said communication module is normal, said CPU module resets said modem.

3. The monitoring apparatus according to claim 2, wherein said CPU module resets said modem by restoring the supply of the power to said modem after suspension of the power supply to it.

4. The monitoring apparatus according to claim 1, wherein said CPU module obtains the communication module state information from said CPU module via said data bus when there is a communication abnormality in the communication via a modem connected to any one of the two or more connectors of said communication module, and upon determination that said communication module is abnormal, said CPU module resets said communication module.

5. The monitoring apparatus according to claim 4, wherein said CPU module resets said communication module by transmitting a restart signal to said communication module.

6. The monitoring apparatus according to claim 1, wherein if said communication module determines that its own communication module is abnormal after referring to its own communication module state information when there is a communication abnormality in the communication via the modem connected to any one of the two or more connectors, said communication module resets itself.

7. The monitoring apparatus according to any one of claims 2 to 6, wherein said communication module state information enables the determination of whether a control program for controlling said communication module is operating in a normal manner.

8. The monitoring apparatus according to any one of claims 2 to 6, wherein said communication module state information enables the determination of whether data in said communication module is updated in a normal manner.

9. The monitoring apparatus according to claim 1, wherein said input module is a digital input module for being input with a digital signal and an analog input module for being input with an analog signal.

10. The monitoring apparatus according to claim 1, the apparatus comprising a digital output module for outputting a digital signal.

11. The monitoring apparatus according to claim 10, wherein said digital output module is connected to said modem.

12. The monitoring apparatus according to claim 1, wherein the connectors of said communication module are connected to an input/output device which is connected to said monitored object.
